(19) United States
(12) Patent Application Publication
(10) Pub. No.: US 2012/0274246 A1
(43) Pub. Date: Nov. 1, 2012

(54) ELECTRIC DRIVE AND BATTERY CHARGING POWER ELECTRONIC SYSTEM

(75) Inventor: Mihail Radulescu, Craiova (RO)

(73) Assignee: INDIA S.R.L., Craiova (RO)

(21) Appl. No.: 13/509,208

(22) PCT Filed: Nov. 8, 2010
(86) PCT No.: PCT/IB10/03015

§ 371 Date: May 10, 2012

Related U.S. Application Data
(60) Provisional application No. 61/258,989, filed on Nov. 6, 2009.

(51) Int. Cl. H02P 27/06

(52) U.S. Cl. 318/139

(57) ABSTRACT

An electric drive that provides power from a DC battery to an AC motor and for charging the DC battery when power is being supplied through the motor windings such that no secondary on-board system for charging the battery or specialized charging station is required. A DC battery is in electronic communication with a three-phase inverter that converts DC power received from the battery into an alternating current when a switch is placed into a closed position. The three-phase inverter is in communication with a three-phase stator such that it supplies the stator with the converted AC power. Once power is received by the stator an air flux and electronic current are produced that interact to produce torque on a rotor creating mechanical energy. When the switch is placed in an open position, the three phase stator discontinues supplying almost all the power to the rotor but rather receives alternating current from an already available three-phase voltage network. The alternating current is transferred into the inverter where it is converted into a direct current that is supplied to the battery to recharge the battery. A control device is provided to control how much power is drawn from and supplied to the battery.

### TECHNICAL FIELD

This application is related generally to an electric drive system. More particularly, this invention relates to an electronic drive system having a motor in which the same system provides a means to route power from the battery source to the motor and to power the battery for charging.

### BACKGROUND AND SUMMARY OF THE INVENTION

Three-phase AC motors have become popular as they are more efficient, cost less to build and operate, last longer, and are more dependable than DC motors. Electric drive systems with AC motors include a battery source, an inverter that converts direct current (DC) from the battery source into alternating current (AC), a three-phase stator with windings displaced by 120° that receives alternating current from the inverter, and a rotor situated within the three-phase stator such that it is subjected to a torque when alternating current is supplied to the stator.

Utilization of a three-phase motor as the power source within a vehicle such as a truck or car requires implementation of a separate system for charging the battery source. A first type of secondary system for charging the battery source may consist of an on-board rectifier supplied with alternating current from the three-phase network and in some instances may also include an input transformer positioned between the on-board rectifier and the three-phase network. The reliance on a separate secondary system for charging the battery source for an AC motor adds bulk and weight to the vehicle and thus reduces the vehicle's efficiency. Furthermore, this additional on-board system is costly. Alternatively, a second type of secondary system consists of specially designed charging stations placed along the route that the electric vehicle will traverse so as to provide direct current to the batteries when docked or plugged-in to the charging station or by removing the batteries from the vehicle for recharge. However, such charging stations limit the routes available to the electric vehicle and require substantial expense. There is a need in the art for an electric drive system that does not require a separate secondary system for battery charging such as an additional on-board system or a specially designed charging station discussed above.

The present invention provides an electric drive system that does not require a separate secondary on-board system for charging the battery source or a specially configured charging station that produces direct current. Rather, the present invention uses the components of the drive system to recharge the batteries accepting input from existing three-phase voltage networks (e.g., 3×480V_{AC}@60 Hz or 3×400V_{AC}@50 Hz) and converting the AC current via the electric drive's three phase inverter into direct current. In one exemplary embodiment, an electric drive system comprises a storage battery, a three-phase inverter, a three-phase stator in electronic communication with the inverter and configured to receive power from an already available three-phase voltage network, a rotor, a control device, and a switch. In one exemplary embodiment, putting the switch in a closed position causes the motor to go into drive. When the motor is in drive, DC power flows from the battery source into the three-phase inverter where it is converted into AC power. The freshly converted AC power then flows into the three-phase stator which causes an air gap flux and an induced current to be produced, interaction of which produces torque on the rotor creating mechanical power. The control device may be utilized to set the amount of power drawn from the battery source and thereby control the mechanical power output.

Conversely, opening the switch enables the battery source to be charged. In a preferred exemplary embodiment, the battery source is charged when AC power flows from an already available three-phase voltage network to the three-phase stator windings through the three-phase inverter where it is converted into DC power and finally stored in the DC battery. In this regard, electric vehicles comprising the drive system disclosed herein are recharged by a simple connection to the existing three-phase AC network and do not require special charging stations that convert AC to DC nor a secondary on-board charging system. During the charging phase, the control device may be utilized to set the amount of power that flows into the battery source.

### BRIEF DESCRIPTION OF THE DRAWINGS

A better understanding of the disclosed embodiments will be obtained by a reading of the following detailed description and the accompanying drawings wherein identical reference characters refer to identical parts and wherein:

FIG. 1 shows an exemplary embodiment of the drive system of the present invention where the switch has been set to cause energy to be drawn from the battery source into the three-phase converter and subsequently into the three-phase stator to generate mechanical power.

FIG. 2 shows an exemplary embodiment of the drive system of the present invention where the switch has been set to cause energy to be drawn from an already available three-phase voltage network into the three-phase stator and subsequently into the DC battery for charging.

### DETAILED DESCRIPTION

The present invention provides a drive system that does not require a separate on-board system for charging the battery source or a specially configured charging station that produces direct current. In one exemplary embodiment, an electric drive system comprises a storage battery 10, a three-phase inverter 20, a three-phase stator 30 in electronic communication with the inverter 20 and configured to receive power from an already available three-phase voltage network 40, a rotor 50, a control device 60, and a switch 70. The present invention requires that the motor be a three-phase AC motor. In some embodiments, the motor may be an induction motor while in other embodiments the motor may be a synchronous motor with windings or permanent magnets inside the rotor.

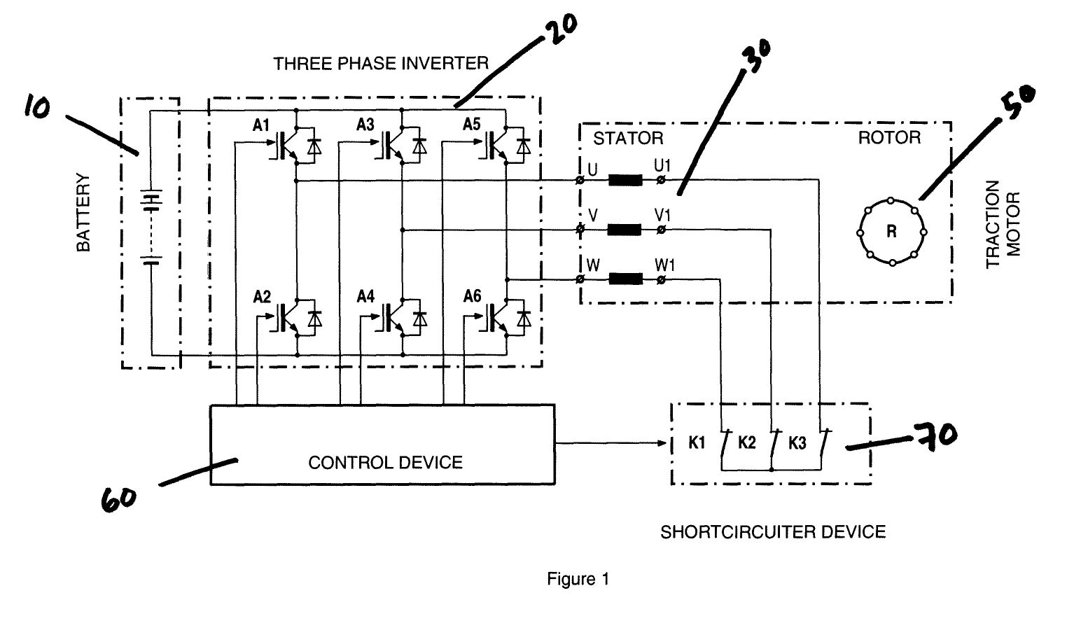

In a preferred exemplary embodiment, the switch 70 of the disclosed electric drive system can be placed in an open or closed position. When the switch 70 is placed in the closed position, the electric drive system is placed into its drive function. FIG. 1 illustrates an exemplary embodiment of the present invention where the switch 70 has been placed in a closed position. In drive, DC power flows from the battery source 10 into the three-phase inverter 20 where it is converted into a three-phase alternating current that is then supplied to the three-phase stator 30. Once the windings of the three-phase stator 30 receive the electric current, a sinusoidal distributed air gap flux is produced. The sinusoidal distributed air gap flux in turn generates a rotor current. When the air gap flux and the rotor current interact, a torque is produced on the rotor 50 causing it to turn. In a preferred embodiment, the control device 60 is utilized to set the amount of power drawn from the battery source and thus control the motor's speed.

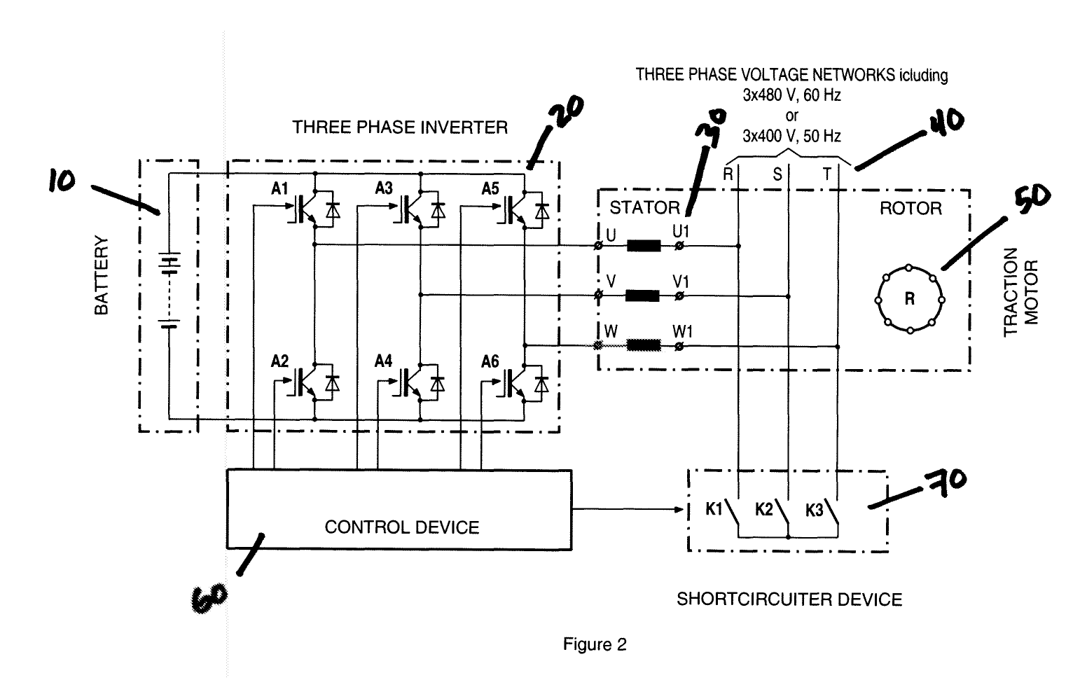

Conversely, when the switch 70 is placed in the open position, the disclosed electric drive system functions to charge the battery source 10. FIG. 2 provides an exemplary embodiment of the present invention where the switch 70 has been placed in the open position to charge battery source 10. In a preferred exemplary embodiment, the battery source 10 is charged when AC power flows from the already available three-phase voltage network 40 to the three-phase stator 30 windings through the three-phase inverter 20 where the power is converted to DC. Because of the internal diodes the three-phase inverter 20 acts as a three phase rectifier during the charge cycle to convert the received AC into DC. Additionally, the three-phase inverter 20 is controlled as a step up DC chopper using the inductance of the stator 30 windings to boost the DC current produced by the free wheel diodes of the three-phase inverter 20 before it is delivered to the battery. The current is then directed to the DC battery 10 causing the battery 10 to be charged. In an exemplary embodiment, the three-phase voltage network 40 comprises three circuit conductors that carry three alternating currents (of the same frequency) which reach their instantaneous peak values at different times. One example of an already available three-phase voltage network 40 that may be utilized to supply the three-phase stator 30 with battery-charging current is 3×480 V_{AC}, 60 Hz. Additionally, other non-standard voltages can be used such as 3×220V_{AC} or 3×110V_{AC} at either 50 Hz or 60 Hz.

In a preferred exemplary embodiment, the battery source 10 of the present invention comprises a battery of storage cells of 125 kWh. For example, the battery may be comprised of 240 LiFePO₄ cells each having a capacity of 160 Ah. Other types of batteries may be used, for example, those based on LiFeYPO₄ or other technology having similar storage capacity. The series connection of the cells provides 1000V_{DC}. However, the connection of cells may be sized to produce any necessary output, e.g., 100V_{DC} or 500V_{DC}. The number of cells utilized within the battery can be varied in some exemplary embodiments when higher or lower power outputs are required.

In a preferred exemplary embodiment, when the electric drive system is being utilized to charge the battery source 10, operation of the three-phase inverter 20 is regulated by the control device 60.

In one exemplary embodiment of the present invention, the three-phase stator 30 may comprise specially designed stator winding. For example, in designing the stator winding for a motor with different pole pairs, it is advantageous to connect, in series or in parallel, different winding sections per phase. By doing this, one obtains a coil group that allows for additional supply system options. For example, one could use one, two, or four distinct converters which can act in the same way to charge the battery.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A system for driving an alternating current (“AC”) traction motor having a rotor, comprising:
a battery for storing and delivering direct current (“DC”) electrical power;
a multiphase electrical inverter, in electrical communication with the battery to receive DC power from the battery when the system is arranged in a first condition and to transfer DC power to the battery when the system is arranged in a second condition;
a stator, having the same number of phases as the inverter, in electrical communication with the inverter to receive AC power from the inverter when the system is in the first condition and to transfer AC power to the inverter when the system is in the second condition, the stator further positioned relative to the rotor to generate torque therein when the system is in the first condition and to generate negligible torque when the system is in the second condition;
an electrical input, in electrical communication with the stator to deliver AC power from an external AC power source to which the input is connected when the system is in the second condition, the electrical input being isolated from the stator when the system is in the first condition;
a switch for selectively changing the system arrangement between the respective first and second condition.

2. The system of claim 1, further comprising:
a controller, in communication with at least the inverter and the switch, for setting the condition of the system.

3. The system of one of the preceding claims, wherein:
the multi-phase inverter is a three-phase inverter.

4. The system of claim 1 or claim 2, wherein:
the battery is a plurality of interconnected storage cells.

5. The system of claim 4, wherein:
the storage cells comprise LiFePO₄ cells.

6. The system of claim 4 or claim 5, wherein:
each storage cell provides at least about 160 Ah.

7. The system of claim 3, wherein:
the electrical input is configured to receive a conventional plug for three-phase alternating current.

8. The system of claim 7, wherein:
the electrical input is configured to receive a conventional plug for delivering 480 volt or 400 volt alternating current, at a conventionally local frequency of either 50 or 60 Hz.

9. The system of claim 4, wherein:
the plurality of interconnected storage cells are connected to deliver at least about 1000 volts direct current to the inverter.

10. A method of driving a traction motor, comprising the steps of:
providing a system according to claim 1; and
using the switch of the system to selectively set the system into the first condition or the second condition, such that:
when in the first condition, direct current (“DC”) power from the battery is converted into multiphase AC power in the inverter and generates drive torque in the motor; and
when in the second condition, AC power from an external source thereof is communicated through the electrical input through the stator to the inverter,
where the AC power is converted into DC power that is delivered to the battery
and the drive torque in the rotor is negligible.

11. The method of claim 10, further comprising the step of:
using a signal from a controller in communication with the switch to change the condition of the system.

12. A vehicle, comprising:
a drive system powered by a system of claim 1, the motor being in mechanical communication with at least one set of drive wheels.

13. The vehicle of claim 12, wherein:
an onboard computer of the vehicle is in communication with the switch to change the condition of the system.

14. The vehicle of claim 12, wherein:
the electrical input is configured to receive a conventional plug for three-phase alternating current.
